(19) United States
(12) Patent Application Publication
(10) Pub. No.: US 2025/0037109 A1
(43) Pub. Date: Jan. 30, 2025

(54) SYSTEMS AND METHODS FOR GENERATION OF SECURE SELF-SOVEREIGN IDENTIFICATION WITH A CONTACTLESS CARD

(71) Applicant: Capital One Services, LLC, McLean, VA (US)

(72) Inventor: Robert Raymond MANTONI, JR., Restib, VA (US)

(21) Appl. No.: 18/226,083

(22) Filed: Jul. 25, 2023

(51) Int. Cl. G06Q 20/34; G06Q 20/40

(52) U.S. Cl. CPC G06Q 20/352; G06Q 20/401

(57) ABSTRACT

The disclosed systems and methods are directed to streamlining and enhancing feasibility of identity assertion in an online environment (e.g., distributed reputation network). The systems and methods facilitate conversion of user-specific data stored on a contactless card into a verified and/or authenticated identity token, via an application of NFC-enabled encrypted authentication process customized for optimizing identity assertion in block-chain network (e.g., association of reputation data blocks in a blockchain reputation network to a unique user-controlled identifier). The systems and methods leverage the proofed identity that can be generated by the encrypted authentication process initiated by a contactless card and stored thereupon for on-demand NFC transmission via a reader, to streamline generation of a user-specific authenticated digital identity token conforming with a self-sovereign identification model.

### FIELD OF THE DISCLOSURE

The present disclosure relates to systems and methods for digital identity verification, and more specifically for generation of a self-sovereign identification on a distributed reputation network.

### BACKGROUND

The absence of reliable network identifiers is one of the primary sources of cybercrime, fraud, and threats to privacy on the internet. Networking protocols provide identifiers for devices, but not for the people and organizations operating the devices. Instead, online identity assertion is generally provided by a number of large identity providers, such as social networking sites and email providers, that generally track and control user personal data.

It is generally recognized that in self-sovereign identification (SSI) systems users control the verifiable credentials that they hold. Accordingly, a self-sovereign identification allows individuals and/or entities to self-manage their digital identities without depending on third-party providers to store and manage the data. This reduces the unintended sharing of users' personal data.

Self-sovereign identification (SSI) is prominently used in blockchain-based reputation data networks. As such, the SSI model is generally implemented using blockchain technology and stored on a blockchain network. Therefore, there exit a need for an improved and streamlined way of generating self-sovereign user identities for use across blockchain networks such as s distributed reputation data network.

### SUMMARY OF THE DISCLOSURE

One aspect of the present disclosure is directed to a method for self-sovereign identification assertion in a distributed reputation network, the method comprising: storing, by a contactless card, one or more unique data records, wherein the one or more unique data records uniquely identifies a user and/or entity, transmitting, by the contactless card via an intermediary device (e.g., a mobile device with a near field communication (NFC) reader storing an application configured to read the contactless card), the one or more unique data records to an authentication server, verifying, by the authentication server, the one or more unique data records stored on the contactless card, generating, by the authentication server, upon verifying the one or more unique data records, a unique identifier token, distributing, by the authentication server, the unique identifier token, in a reputation network, wherein the verification server corresponds to a trusted entity, and wherein the unique identifier token is further configured to be used as a query identifier for querying one or more reputation providers on the reputation network. The one or more reputation providers are associated with one or more reputation data components associated with a user, the one or more reputation data components comprising records corresponding to educational background, skills, and professional qualifications associated with the user.

In some examples whereby the distributed reputation network is implemented in a block chain environment, distributing the unique token identifier by the authentication server may comprise inserting, by the authentication server, the unique token identifier into one or more reputation data blocks as a metric of identity associated with the user, the one or more reputation data blocks comprising one or more reputation components provided by one or more reputation providers, wherein the one or more reputation data blocks are signed with a private key of a corresponding reputation provider. In accordance to some embodiments, the authentication server may add the reputation data blocks to the distributed reputation network. The reputation data block may include one or more reputation components provided and/or validated by one or more corresponding reputation providers that are part of the reputation network. The identity of the plurality of reputation providers on the network may be authenticated using a corresponding public key associated with the reputation provider.

In some examples the unique token identifier, generated by the authentication server from transmitted data stored on the contactless card, may be transmitted back to the contactless card for storage onto an integrated memory of the contactless card. The unique identifier token may then be communicated from the contactless card (e.g., via a mobile device with a reader) to the distributed reputation network, where it can server as a query identifier for the user and/or an entity associated with the contactless card. Having been generated, by the authentication server, in response to authentication of identification data stored on the contactless card and transmitted therefrom via an intermediary device, the unique token identifier may comprise a digital signature of a trusted entity (e.g., the authentication server). In some examples, the unique identifier token may also be stored on a hierarchical deterministic (HD) hardware wallet, and provided therefrom, by a user action, to a reputation network to serve as a query identifier for the user and/or entity.

One aspect of the present disclosure is directed to a system for implementing self-sovereign identification assertion in a distributed reputation network, the system comprising a contactless card in a communication with an authentication server, the communication being facilitated via an intermediary device. In line with the system operation, the contactless card may be configured to: internally store one or more unique data records (e.g., on an integrated memory element of the contactless card), wherein the one or more unique data records uniquely identifies a user and/or an entity. The unique data records may then be transmitted, via a wireless read (e.g., using near field communication (NFC)) and communicated to the authentication server for verification. The communication between the contactless card and the authentication server may be enabled by an application running on the intermediary device with near field communication (NFC) connectivity to the contactless card and network connectivity to the verification server. Furthermore, the receiving authentication server, corresponding to a trusted entity, may be configured to: verify, the one or more unique data records stored on the contactless card, generate a unique token identifier upon verifying the one or more unique data records and distribute the unique token identifier, as a query identifier for the entity, in a reputation network, wherein the unique token identifier is configured to be used as the query identifier for querying one or more reputation providers on the reputation network.

One aspect of the present disclosure is directed to a non-transitory computer-accessible medium comprising instructions for execution by a computer hardware arrangement, wherein, upon execution of the instructions the computer hardware arrange is configured to perform procedures comprising: storing one or more unique data records on a contactless card, wherein the one or more unique data records uniquely identifies an entity; transmitting, by the contactless card via an intermediary device, the one or more unique data records to a verification server; verifying, by a verification server, the one or more unique data records stored on the contactless card; generating, by the verification server upon verifying the one or more unique data records, a unique token identifier; distributing, by the verification server, the unique token identifier, in a reputation network, wherein the verification server corresponds to a trusted entity, and wherein the unique token identifier is configured to be used as the query identifier for querying one or more reputation providers on the reputation network. According to some embodiments of the present invention, the unique identifier token may be transmitted to the contactless card for storage onto an integrated memory of the contactless card, wherein the contactless card is configured to transmit the unique token identifier, as a query identity, to a reputation network.

In scenarios wherein the reputation network corresponds to a distributed network implemented in a blockchain context, the non-transitory computer-accessible medium may further comprise instructions for inserting, by the verification server, the unique token identifier into one or more reputation data blocks as a metric of identity associated with the entity, the one or more reputation data blocks comprising one or more reputation components provided by one or more reputation providers, wherein the one or more reputation data blocks are signed with a private key of a corresponding reputation provider.

### BRIEF DESCRIPTION OF THE DRAWINGS

Various embodiments of the present disclosure, together with further objects and advantages, may best be understood by reference to the following description taken in conjunction with the accompanying drawings.

FIG. 1A illustrates a general overview of various components generally associated with implementation of a self-sovereign identification (SSI) that can be used as a query identifier on a reputation network blockchain, in accordance to some embodiments of the present disclosure.

FIG. 1B illustrates an exemplary process for secure identity assertion, using a contactless card, that can be used as an query identity on a reputation network blockchain, in accordance to some embodiments of the present disclosure.

FIG. 1C illustrates an exemplary system implementation of identity assertion initiated by, and administered from a contactless card, in accordance to some embodiments of the present disclosure.

FIG. 2. illustrates an exemplary embodiment corresponding to generation and distribution of an identity assertion token directly from a trusted entity, associated with a contactless card. to a blockchain reputation network, in accordance to some embodiments of the present disclosure

FIG. 3 illustrates an exemplary reputation data block incorporating the identity assertion token associated with user-initiated authentication of encrypted card-stored data.

FIG. 4 illustrates an exemplary process flow for generation and distribution of the identity assertion token as a query identifier on reputation network, in accordance to some embodiments of the present disclosure.

FIG. 5 illustrates an exemplary timing sequence diagram for an identity assertion token administered, upon user-demand, directly from an authentication server (trusted entity), in accordance to some embodiments of the present disclosure.

FIG. 6 illustrates an exemplary timing sequence diagram for an identity assertion token administered, via a user action, directly from a contactless card, in accordance to some embodiments of the present disclosure.

FIG. 7 is an illustration of an exemplary block diagram of an exemplary system, in accordance to some embodiments of the present disclosure.

### DETAILED DESCRIPTION

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

Furthermore, the described features, advantages, and characteristics of the exemplary embodiments may be combined in any suitable manner. One skilled in the relevant art will recognize that the exemplary embodiments may be practiced without one or more of the specific features or advantages of an exemplary embodiment. In other instances, additional features and advantages may be recognized in certain exemplary embodiments that may not be present in all exemplary embodiments. One skilled in the relevant art will understand that the described features, advantages, and characteristics of any exemplary embodiment can be interchangeably combined with the features, advantages, and characteristics of any other exemplary embodiment.

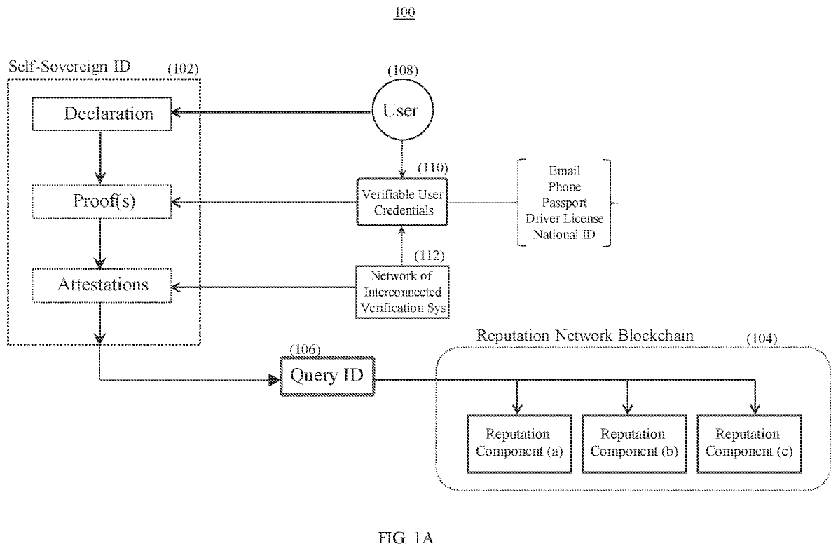

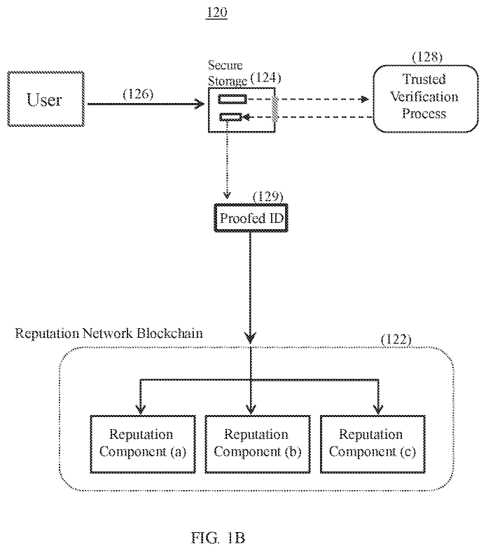

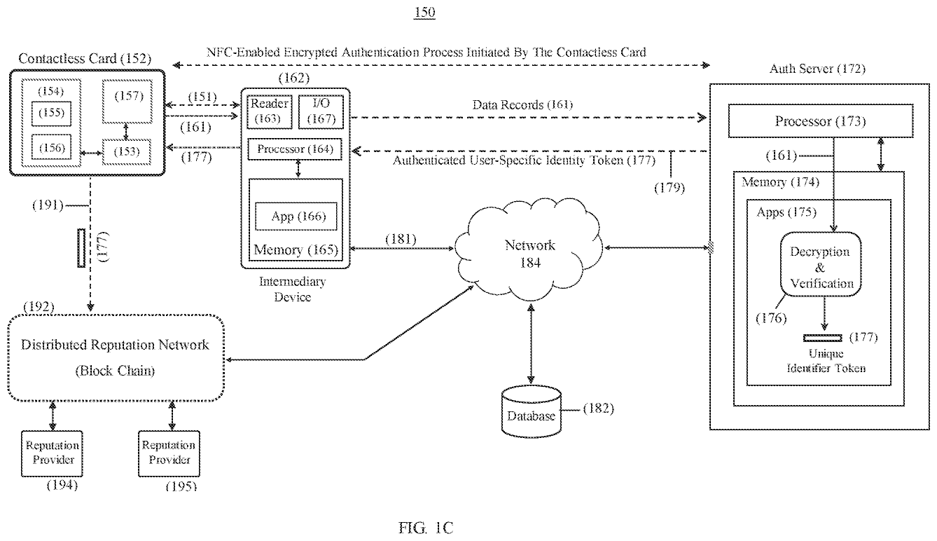

The self-sovereign identification (SSI) model may be particularly useful in assertion of identity in a blockchain-based reputation network. FIG. 1A illustrates a general overview of various components associated with a self-sovereign identification model 100. The corresponding self-sovereign identification 102 may be stored on a reputation network blockchain 104 and used as query identifier 106 for retrieval of reputation data (e.g., reputation components a-c) associated with a user 108. The components generally comprise a declaration provided by the user 108, a set of identity proofs corresponding to verifiable user credentials 110, and attestation of validity, for the verifiable user credentials 104, provided by a network of verification entities 112 participating in the reputation network 104.

One aspect of the present disclosure is to provide a streamlined process for implementation of an identity assertion token that encompass the advantage of the self-sovereign identification model, in allowing a user to fully own and control their data, thus providing an increased security and privacy, while eliminating reliance on third-party services for storage and provision of user data. FIG. 1B illustrates an exemplary process overview 120 for streamlining implementation of identity assertion, for example, on a reputation data network 122. The illustrated implementation is based on user-controlled secure storage of identification data (e.g., secure storages 124) that is readily transmittable, upon user demand 126, to a trusted verification process 128 for conversion into an authenticated and/or trusted user-specific identifier token 129 that can server as a proofed identification (ID) on the reputation network blockchain 122. An exemplary system implementation of the described solution is illustrated in FIG. 1C.

FIG. 1C illustrates an exemplary system implementation 150 for generation and provision of an identity assertion metric using a contactless card 152 readable via shot-range wireless communication 151 with an intermediary device 162 (e.g., a mobile device). The process to generate a trusted unique identifier (e.g., an identity assertion token 177) may be initiated by the contactless card 152, when brought into a wireless communication field of the intermediary device 162, and may be enabled by an authentication of encrypted identification data 161 stored securely on the contactless card 152. The proofed identity, generated in form of a unique digital token (e.g., user-specific identity assertion token 177) can be controlled by the user, and provided on-demand as an identity assertion metric, without reliance on data-sharing third party services. For example, The digital identity assertion token 177 can be stored on the contactless card 152 and provided by direct user action via an NFC reader to a blockchain network (e.g., distributed reputation network 192). The digital identity assertion token may also be stored on the authentication sever 172 (where it is generated), in which case the token may be directly provided via and/or distributed from the authentication server 172 (e.g., a trusted entity), upon user demand. In some embodiments, the digital identity assertion token may be distributed to a reputation network, for incorporation into user reputation blocks and/or used as a query identity, directly from the authentication server, in response to a user command transmitted, for example, via a user intermediary device 162.

In some examples, exemplary procedures in accordance with the present disclosure described herein can be performed by a processing arrangement and/or a computing arrangement as illustrated by the exemplary system 150. The set of operations involved in conversion of card-stored user data into a authenticated digital identity token may be executed on one or more network-enabled computers. As referred to herein, a network-enabled computer can include, but is not limited to a computer device, or communications device including, e.g., a server, a network appliance, a personal computer, a workstation, a phone, a handheld PC, a personal digital assistant, a thin client, a fat client, an Internet browser, a mobile device, a smart card (e.g., a contactless card or a contact-based card), a kiosk, or any other network-enabled computing and/or communication device. or other devices.

FIG. 1C illustrates an exemplary system 150 for implementation of secure identity assertion on a distributed reputation network based on an identity assertion token (e.g., data element 177) generated via a set of interactions between a contactless card 152, an intermediary device 162 and an authentication server 172 associated with the contactless card and/or the intermediary device. As described herein, the identity assertion token 177 may then be provided to a distributed reputation network 192 comprising a plurality of reputation providers (e.g., 194, 195). One aspect of the provisioning process may include insertion of the identity assertion token into one or more reputation data blocks corresponding to the user. The identity assertion token 177 may then used as a query identifier for a user and/or entity on the distributed reputation network 192, which may be implemented as a blockchain network.

As described in relation with FIG. 1B, the identity assertion token (e.g., 177) may be generated by a trusted verification/authentication process (e.g., process 176) applied to one or more identification parameters and credentials (e.g., data 161) securely stored on and retrieved from the contactless card 152 associated with a user. The verification process 176 may be running on the authentication server 172 which may be configured to transmit the identity assertion token 177 back to the contactless card 152 (e.g., via the intermediary device 162) as denoted by data transfer 179 in the exemplary system implementation 150. The identity assertion token 177 may then be stored onto an integrated memory 154 of the contactless card 152. The contactless card 152 may then be configured to transmit, upon user demand, the unique token identifier 177 to the distributed reputation network 192. The identity assertion token may be provided to the blockchain network (e.g., distributed reputation network 192) by a direct user-initiated NFC transmission 191 and/or via the intermediary device 162 with a network connection 181. In some embodiments the identity assertion token 177 may include a digital signature of the verification server 172 serving as a trusted entity. In some examples, may be encrypted by the authentication server 172, and an encrypted identity assertion token may be transmitted back to the contactless card 152. In such scenarios, the contactless card 152 may decrypt the received identity assertion token prior to storing it onto its integrated memory for on-demand usage.

Referring back to FIG. 1C, the system 150. The contactless card may comprise an integrated processor 153 (e.g., one or more microprocessors) and memory 154 (e.g., random access memory, read only memory, programmable read-only memory, erasable programmable read-only memory, electrically erasable programmable read-only memory) that may store, for example, user identifying and/or authenticating information as near field communication (NFC) transmittable data (e.g., NFC Data Exchange Format (NDEF)). The integrated memory 154 may store one or more applets 155 that may be communicatively coupled to one or more applications (e.g. application 168) running on the intermediary device 162 (e.g., a user communication and/or computing device) and/or one or more applications 175 running on the authentication server 172. The card-integrated memory 154 may also store an application transaction counter 156 to keep track of a proper sequence of operations associated with an authentication transaction conducted using contactless card 152. The contactless card may further comprise a Near Field Communication (NFC) interface 157 to facilitate an NFC communication with an NFC reader (e.g., reader component 163 of the intermediary device 162). The (optionally encrypted) user identification information may then be directly captured by the reader component 163 of the intermediary device by bringing the contactless card 152 within an NFC range of the intermediary device (e.g., by tapping the contactless card on a reader of a user mobile device) to initiate a direct read and subsequent authentication of user identification information stored, as NFC transmittable data, on the contactless card 152.

In some examples, the intermediary device for wireless communication with the contactless card via a short-range wireless connection (e.g., an NFC link) and communication with the authentication server via a network connection 169, may correspond to network-enabled computer such a user intermediary device 162 which can include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. The user intermediary device 162 may include a reader 163 for communicating with the contactless card, a processor 164, a memory 165 storing one or more applications 166, and an input/output interface 167 for receiving user-input data and providing output data (such as wireless data transmission to the authentication server and/or display data to the user). The processor 164 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The authentication server 172 may be a network-enabled computer. The authentication server 172 may include a processor 173 and a memory 174 storing one or more applications 175. In some examples, the verification process 176 may be running as part of the one or more application 175. The unique identifier token 177 generated by the verification process 176 may be stored in the memory 174 and communicated by the processor 173 to the processor 164 of the intermediary device 162. The processor 173 may be a processor, a microprocessor, or other processor, and the authentication server 172 may include one or more of these processors. The processor 173 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein. The authentication server 172 may be communicatively coupled to a database 182 and a distributed network 192 that may be configured to communicate with the authentication server 172 via a public and/or a private network connection 184. The network 184 may also facilitate communication between different components illustrated in FIG. 1C. Although FIG. 1C illustrates single instances of each components, the system 150 may include any number of components.

The database 182 may be one or more databases configured to store data, including without limitation, one or more user identifying and/or financial accounts information, one or more merchant-specific transaction histories. The database 182 may comprise a relational database, a non-relational database, or other database implementations, and any combination thereof, including a plurality of relational databases and non-relational databases. In some examples, the database 182 may comprise a desktop database, a mobile database, or an in-memory database. Further, the database 182 may be hosted internally by the authentication server 172 or may be hosted externally and communicatively coupled with the authentication server via network 184. The database 182 may store processed user information, mapping data, etc.

The system 150 may include one or more networks 184. In some examples, the network 184 may be one or more of a wireless network, a wired network or any combination of wireless network and wired network, and may be configured to connect the user (transmitting) device (e.g., 162), the authentication server 172 and one or more reputation providers via the distributed blockchain reputation network 192. The network 184 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 184 may include, without limitation, telephone lines, fiber optics, IEEE Ethernet 902.3, a wide area network, a wireless personal area network, a LAN, or a global network such as the Internet. In addition, the network 184 may support an Internet network, a wireless communication network, a cellular network, or the like, or any combination thereof. The network 184 may further include one network, or any number of the exemplary types of networks mentioned above, operating as a stand-alone network or in cooperation with each other. The network 184 may utilize one or more protocols of one or more network elements to which they are communicatively coupled. The network 184 may translate to or from other protocols to one or more protocols of network devices. Although the network 184 is depicted as a single network, it should be appreciated that according to one or more examples, the network 184 may comprise a plurality of interconnected networks, such as, for example, the Internet, a service provider's network, a cable television network, corporate networks, such as credit card association networks, and home networks. The network 184 may further comprise, or be configured to create, one or more front channels, which may be publicly accessible and through which communications may be observable, and one or more secured back channels, which may not be publicly accessible and through which communications may not be observable

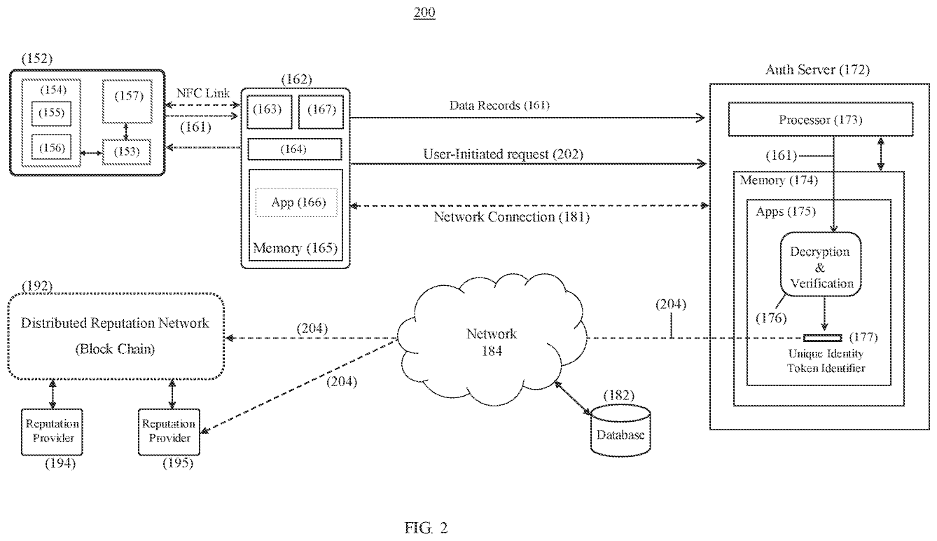

FIG. 2 illustrates exemplary implementation 200 for contactless-based identity assertion on a distributed blockchain reputation network. In the example 200, the unique identity token, generated by the authentication server is stored and administered directly from the authentication server. As described with reference to the example 150, the administration of the unique identifier token may involve distribution of the unique identifier token to the relevant set of participating reputation providers associated with the user. The unique identifier token may also be provided to one or more entities as a query identifier for retrieving user reputation data from one or more reputation providers participating in the distributed reputation network. As described above, these reputation providers may correspond, for example, to educational and career institutions affiliated with the user. In the exemplary embodiment 200, illustrated in FIG. 2, the unique identifier token, upon being generated as a result of encrypted authentication process initiated by the contactless card 152, may be stored on the authentication server 172. The unique identifier token may then be directly provided, to the distributed reputation network 192, from the authentication response in response to a user initiated request 202 received from a user communication device 162. Upon receiving the user-initiated request 202, the authentication server may transmit the unique identity token, for example, via data transfer path 204 going through network 184, to the distributed reputation network 192.

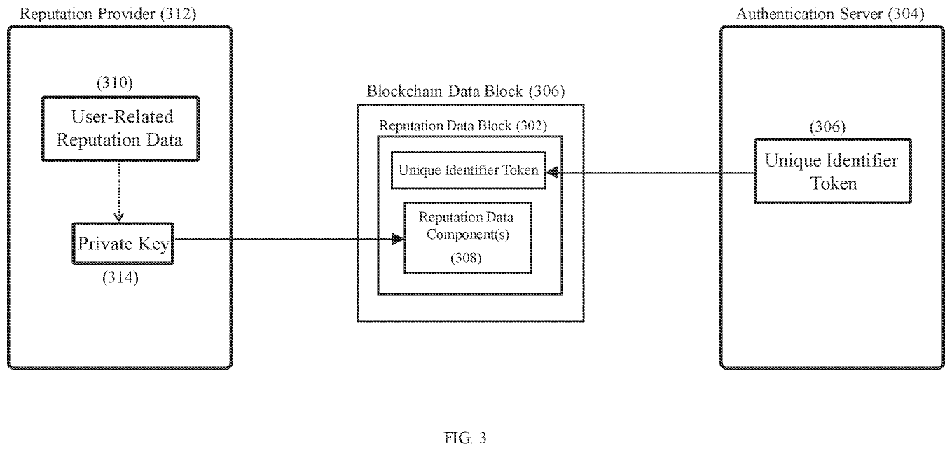

FIG. 3 illustrates an exemplary implementation of a reputation data block 302 using the identity assertion token 303 generated by the authentication/verification server 304 (e.g., in response to authentication of encrypted data records stored on a user contactless card). According to the exemplary implementation 300, the reputation data block 302 may be encapsulated within a blockchain data component 306. The Reputation data block, incorporating the identity assertion token 303 as a user identification parameter, may further include one or more reputation data elements 308 corresponding to user-related reputation data 310, stored on, and may be provided by, one or more reputation provider entities 312. User-related reputation data may be digitally signed by a reputation provider entity (e.g., using a private key 314). In some embodiments, the verification server may be further configured to add the reputation data block (e.g., reputation data block 302) to the reputation network. The one or more reputation data elements 308 may then be inserted into the reputation data block by the one or more reputation provider entities 312. In some embodiments, the one or more reputation data components may be retrieved by the verification server from the one or more reputation provider entities (e.g., via one or more application programming interface (API) calls to the one or more reputation data providers) and inserted, by the verification server, into the reputation data block prior to (or after) adding the reputation data block to the reputation network. The one or more reputation data components may comprise data records corresponding to educational background, skills, and professional qualifications associated with a user and/or an entity.

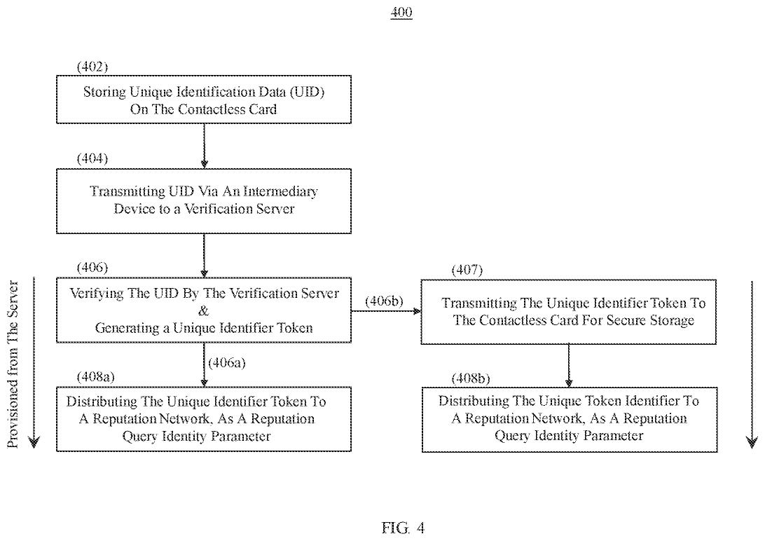

FIG. 4 illustrates an exemplary process flow involved in conversion of user-specific data stored on a contactless card into a trusted identity assertion token, encrypted contactless authentication process customized for optimizing identity assertion in block-chain network (e.g., reputation network). The exemplary process flow 400 may involve an initial step 402 corresponding to storage of one or more unique identification records, as NFC-transmittable data, on a contactless card associated with a user. The one or more unique identification records may be adapted for uniquely identifying a specific contactless card, a specific user associated with the contactless card and/or a specific account associated with the user and/or the contactless card.

The unique identification record may be retrieved via an NFC read of the contactless card by an intermediary device, and transmitted to an authentication server for verification at step 404. The unique identification data may be encrypted based on one or more unique derived card keys (UDKs) stored on the contactless card. The encryption may be further diversified using dynamic data stored on the contactless card (e.g., a transaction counter value), prior to transmission to the intermediary device. At step 406, the authentication server may decrypt and authenticated the encrypted identification data, wherein upon a successful authentication, the authentication server may generate a unique digital token (e.g., an identity assertion token) that encompass and represent the identity of the user and/or the contactless card associated with the user.

The exemplary process flow 400 illustrates two different data paths, corresponding to 406a and 406b, for storage and distribution of the identity assertion token generated through the interactions of the contactless card with the authentication server, through the intermediary device, as described by steps 402-406. For example, based on data path 406a, the authentication server may store and directly provide the identity assertion token to a reputation network, in response to a user request transmitted from a user device (e.g., an intermediary device), as shown by step 408a. Another implementation, based on data path 406b, involves transmitting the identity assertion token back to the contactless card for secure storage thereon, as shown by step 407. At step 408b, the identity assertion token may be provided to requesting system (e.g., a reputation network) via a user action by initiating a read of the contactless card by a reader. The read of the contactless card may be performed by a designated reader component associated with the receiving system and/or the intermediary device (e.g., a user mobile device), in which case the provision of the identity assertion token may occur, from the intermediary device, via a network connection.

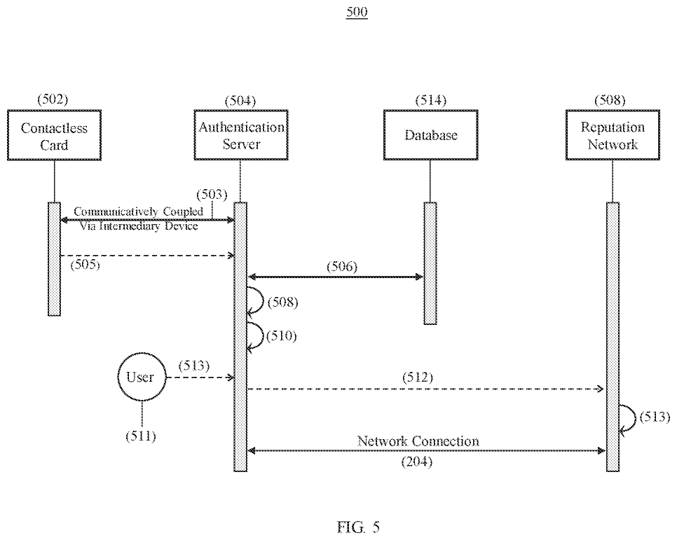

FIG. 5 illustrates an exemplary timing sequence diagram 500 involving storage and administration of an identity assertion token by an authentication server 504 communicatively coupled to a contact less card 502, across a communication link 503. The communication link 503 may be provided via an intermediary device, configured with NFC connectivity to the contactless card 502 and a wireless and/or wired network connectivity to the authentication server 504. At 505, responsive to a wireless read of the contactless card by the intermediary device, one or more user-related identification records stored on an integrated memory of the contactless card 502 are communicated to the authentication server 504. The transmitted identification records may be encrypted by the contactless prior to transmission, via the intermediary device, to the authentication server 504.

The authentication server 504 may be communicatively coupled to a database 514. Information required for decryption and authentication of the received identification records may be stored, in part or in whole, on the database 514 and communicated to the authentication server, upon request. Database 514 may be internally hosted by the authentication server. In some embodiments, the information required for decryption and authentication of data retrieved from the contactless card may be on an internal memory of the authentication server. Upon accessing said information, the authentication server may decrypt and authenticate the identification records retrieved from the contactless card 502 (e.g., 508) and generate a unique digital token encompassing the identification records, as illustrated by operation 510. The unique digital token may represent a unique identity assertion token associated with the user 511. The unique identity assertion token may then be transmitted, in response to a user-initiated request 513 (e.g., initiated via the intermediary device), to a reputation network 508 across a network connection 514. The unique identity assertion token (e.g., user-specific identifier) may then applied to the reputation network 508 as illustrated by operation 513.

The application of the unique identity assertion token to the reputation network may involve insertion of the identity assertion token into one or more reputation data blocks comprising user-related reputation data and/or implementation as a query identification parameter for compiling reputation data relating to the user 511. In some embodiments application of the unique identity assertion token to the reputation network 508 may be carried out, in part or in whole, by the authentication server 504.

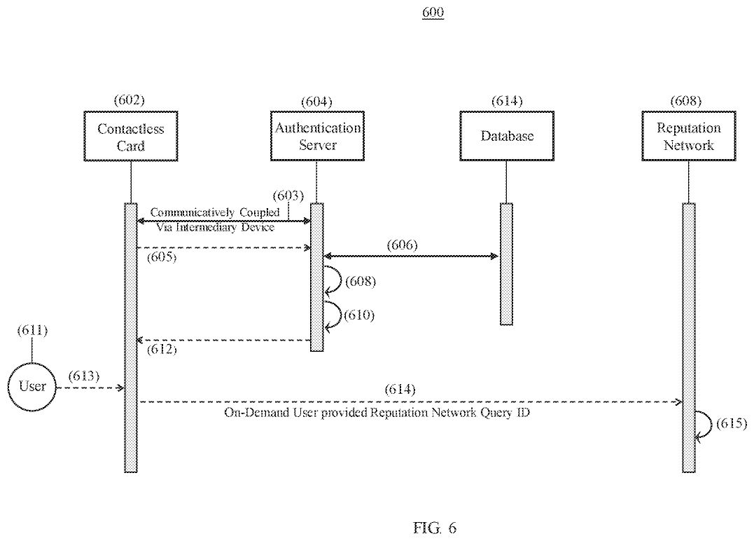

FIG. 6 illustrates an exemplary process flow diagram 600 involving storage and administration of an identity assertion token by a contactless card 602 communicatively coupled to an authentication server 604, across a communication link 603. The communication link 603 may be provided via an intermediary device, configured with NFC connectivity to the contactless card 602 and a wireless and/or wired network connectivity to the authentication server 604. At 605, responsive to a wireless read of the contactless card 602 by the intermediary device, one or more user-related identification records stored on an integrated memory of the contactless card are communicated to the authentication server 604. The transmitted identification records may be encrypted by the contactless prior to transmission, via the intermediary device, to the authentication server 604.

The authentication server 604 may be communicatively coupled to a database 614. Information required for decryption and authentication of the received identification records may be stored, in part or in whole, on the database 614 and communicated to the authentication server upon request. In some embodiments, database 614 may be internally hosted by the authentication server 604. In some embodiments, the information required for decryption and authentication of data retrieved from the contactless card 602 may be stored on an internal memory of the authentication server 604. Upon accessing said information, the authentication server may decrypt and authenticate the identification records retrieved from the contactless card 602 (e.g., 608) and generate a unique digital token encompassing the identification records (e.g., 610). The unique digital token may represent a unique identity assertion token associated with the user 611. The unique identity assertion token may then be transmitted, in response to a user-initiated request 613 (e.g., initiated via the intermediary device), to a reputation network 608 across a network connection 614. The unique identity assertion token (e.g., user-specific identifier) may then applied to the reputation network 608 as illustrated by operation 615.

The application of the unique identity assertion token to the reputation network may involve insertion of the identity assertion token into one or more reputation data blocks comprising user-related reputation data and/or implementation as a query identification parameter for compiling reputation data relating to the user 611. In some embodiments application of the unique identity assertion token to the reputation network 608 may be carried out, in part or in whole, by the authentication server 604. The unique identity assertion token (e.g., user-specific identifier) may then be inserted into a reputation data blocks comprising user-related reputation data and/or used as a query identification for compiling reputation data relating to the user 611.

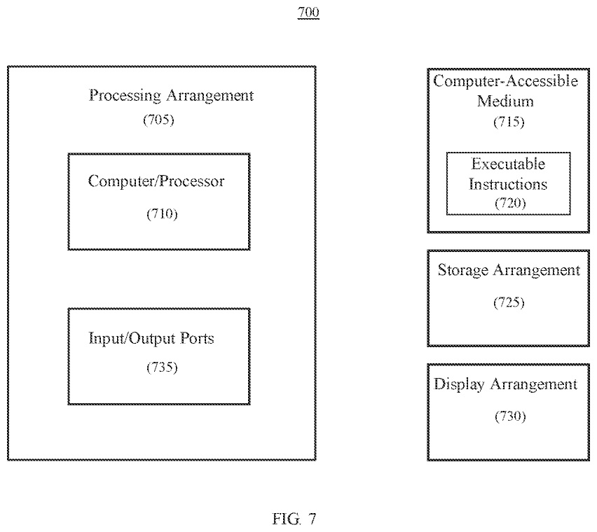

FIG. 7 shows a block diagram of an exemplary embodiment of a system according to the present disclosure. For example, exemplary procedures in accordance with the present disclosure described herein can be performed by a processing arrangement and/or a computing arrangement (e.g., computer hardware arrangement 705). Such a processing and/or computing arrangement 705 can be, for example entirely or a part of, or include, but not limited to, a computer and/or processor 710 that can include, for example one or more microprocessors, and use instructions stored on a computer-accessible medium (e.g., RAM, ROM, hard drive, or other storage device).

As shown in FIG. 7, for example a computer-accessible medium 715 (e.g., as described herein may comprise, a storage device such as a hard disk, floppy disk, memory stick, CD-ROM, RAM, ROM, etc., or a collection thereof) can be provided (e.g., in communication with the processing arrangement 705) The computer-accessible medium 715 can contain one or more executable instructions 720 stored thereon. In addition or alternatively, a storage arrangement 725 can be provided separately from the computer-accessible medium 715, which can provide the instructions to the processing arrangement 705 so as to configure the processing arrangement to execute certain exemplary procedures, processes, and methods, as described herein above, for example.

Further, the exemplary processing arrangement 705 can be provided with or include an input/output ports 735, which can include, for example a wired network, a wireless network, the internet, an intranet, a data collection probe, a sensor, etc. As shown in FIG. 7, the exemplary processing arrangement 705 can be in communication with an exemplary display arrangement 730, which, according to certain exemplary embodiments of the present disclosure, can be a touch-screen configured for inputting information to the processing arrangement in addition to outputting information from the processing arrangement, for example. Further, the exemplary display arrangement 730 and/or a storage arrangement 725 can be used to display and/or store data in a user-accessible format and/or user-readable format.

In some aspects, the techniques described herein relate to a method for self-sovereign identification assertion in a distributed reputation network, the method including: storing, by a contactless card, one or more unique data records, wherein the one or more unique data records uniquely identifies an entity; transmitting, by the contactless card via an intermediary device, the one or more unique data records to a verification server; verifying, by a verification server, the one or more unique data records stored on the contactless card; generating, by the verification server upon verifying the one or more unique data records, a unique token identifier; and distributing, by the verification server, the unique token identifier, in a reputation network, wherein the verification server corresponds to a trusted entity, and wherein the unique token identifier is configured to be used as a query identifier for querying one or more reputation providers on the reputation network.

In some aspects, the techniques described herein relate to a method, wherein the one or more intermediary devices include a mobile device with a near field communication (NFC) reader storing an application configured to read the contactless card.

In some aspects, the techniques described herein relate to a method, wherein the one or more reputation providers validate one or more reputation components associated with a user, the one or more reputation components including records corresponding to educational background, skills, and professional qualifications associated with the entity.

In some aspects, the techniques described herein relate to a method, wherein distributing the unique token identifier by the verification server includes inserting, by the verification server, the unique token identifier into one or more reputation data blocks as a metric of identity associated with the entity, the one or more reputation data blocks including one or more reputation components provided by one or more reputation providers, and wherein the one or more reputation data blocks are signed with a private key of a corresponding reputation provider.

In some aspects, the techniques described herein relate to a method, further including adding, by the verification server, the reputation data blocks to the distributed reputation network including a plurality of reputation providers, wherein each of the plurality of reputation providers is authenticated using a corresponding public key associated with the reputation provider.

In some aspects, the techniques described herein relate to a method, wherein distributing the unique token identifier, as a query identifier for the entity, in a reputation network, corresponds to storing the unique token identifier on a hierarchical deterministic (HD) hardware wallet, the unique token identifier including a digital signature of the verification server as the trusted entity.

In some aspects, the techniques described herein relate to a method, wherein the HD hardware wallet is used to provide the unique token identifier, as the query identifier, to the reputation network.

In some aspects, the techniques described herein relate to a method, wherein distributing the unique token identifier, as a query identifier for the entity, in a reputation network, corresponds to transmitting the unique token identifier to the contactless card for storage onto an integrated memory of the contactless card, wherein the contactless card is configured to transmit the unique token identifier, as a query identity, to the distributed reputation network, the unique token identifier including a digital signature of the verification server as the trusted entity.

In some aspects, the techniques described herein relate to a method, wherein a reputation query includes the unique token identifier and one or more reputation components.

In some aspects, the techniques described herein relate to a method, wherein the distributed reputation network is implemented in a blockchain environment.

In some aspects, the techniques described herein relate to a system for implementing self-sovereign identification assertion in a distributed reputation network, the system including a contactless card in a communication with an authentication server, the communication being facilitated via an intermediary device, the contactless card being configured to: store one or more unique data records, wherein the one or more unique data records uniquely identifies an entity; and transmit, via the intermediary device, the one or more unique data records to the authentication server for verification; and the authentication server being configured to: verify, the one or more unique data records stored on the contactless card, wherein the verification server corresponds to a trusted entity; generate a unique token identifier upon verifying the one or more unique data records; and distribute the unique token identifier, as a query identifier for the entity, in a reputation network, wherein the unique token identifier is configured to be used as the query identifier for querying one or more reputation providers, on the reputation network, for one or more reputation components associated with the entity.

In some aspects, the techniques described herein relate to a system, wherein communication between the contactless card and the authentication server is enabled by an application running on the intermediary device with near field communication (NFC) connectivity to the contactless card and network connectivity to the verification server.

In some aspects, the techniques described herein relate to a system, wherein the one or more reputation components include records corresponding to one or more of educational background, accredited skills, and professional qualifications, associated with the entity.

In some aspects, the techniques described herein relate to a system, wherein the verification server is further configured to insert the unique token identifier into one or more reputation data blocks as a metric of identity associated with the entity, the one or more reputation data blocks including one or more reputation components provided by the one or more reputation providers, the one or more reputation data blocks being signed with a private key of a corresponding reputation provider on the reputation network.

In some aspects, the techniques described herein relate to a system, wherein the verification server is further configured to add the reputation data blocks to the reputation network.

In some aspects, the techniques described herein relate to a system, wherein the verification server is further configured to transmit the unique token identifier to the contactless card for storage onto an integrated memory of the contactless card, wherein the contactless card is configured to transmit the unique token identifier, as a query identity, to the distributed reputation network.

In some aspects, the techniques described herein relate to a method, wherein one or more values for each of the one or more reputation components are provided by the one or more reputation providers participating in the distributed reputation network.

In some aspects, the techniques described herein relate to a non-transitory computer-accessible medium including instructions for execution by a computer hardware arrangement, wherein, upon execution of the instructions the computer hardware arrange is configured to perform procedures including: storing one or more unique data records on a contactless card, wherein the one or more unique data records uniquely identifies an entity; transmitting, by the contactless card via an intermediary device, the one or more unique data records to a verification server; verifying, by a verification server, the one or more unique data records stored on the contactless card; generating, by the verification server upon verifying the one or more unique data records, a unique token identifier; and distributing, by the verification server, the unique token identifier, in a reputation network, wherein the verification server corresponds to a trusted entity, and wherein the unique token identifier is configured to be used as a query identifier for querying one or more reputation providers on the reputation network.

In some aspects, the techniques described herein relate to a non-transitory computer-accessible medium, further including instructions for inserting, by the verification server, the unique token identifier into one or more reputation data blocks as a metric of identity associated with the entity, the one or more reputation data blocks including one or more reputation components provided by one or more reputation providers, wherein the one or more reputation data blocks are signed with a private key of a corresponding reputation provider.

In some aspects, the techniques described herein relate to a non-transitory computer-accessible medium, wherein distributing the unique token identifier, as a query identifier for the entity, in a reputation network, corresponds to transmitting the unique token identifier to the contactless card for storage onto an integrated memory of the contactless card, wherein the contactless card is configured to transmit the unique token identifier, as a query identity, to the distributed reputation network.

As used herein, the term “card” is not limited to a particular type of card. Rather, it is understood that the term “card” can refer to a contact-based card, a contactless card, or any other card, unless otherwise indicated. It is further understood that the present disclosure is not limited to cards having a certain purpose (e.g., payment cards, gift cards, identification cards, membership cards, transportation cards, access cards), to cards associated with a particular type of account (e.g., a credit account, a debit account, a membership account), or to cards issued by a particular entity (e.g., a commercial entity, a financial institution, a government entity, a social club). Instead, it is understood that the present disclosure includes cards having any purpose, account association, or issuing entity.

The present disclosure is not to be limited in terms of the particular embodiments described in this application, which are intended as illustrations of various aspects. Many modifications and variations can be made without departing from its spirit and scope, as may be apparent. Functionally equivalent methods and apparatuses within the scope of the disclosure, in addition to those enumerated herein, may be apparent from the foregoing representative descriptions. Such modifications and variations are intended to fall within the scope of the appended representative claims. The present disclosure is to be limited only by the terms of the appended representative claims, along with the full scope of equivalents to which such representative claims are entitled. It is also to be understood that the terminology used herein is for the purpose of describing particular embodiments only, and is not intended to be limiting.

It is further noted that the systems and methods described herein may be tangibly embodied in one of more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing and/or processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing and/or processing device receives computer readable program instructions from the network and forwards the computer readable program instructions for storage in a computer readable storage medium within the respective computing and/or processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application specific integrated circuit).

In the preceding specification, various embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

1. A method for self-sovereign identification assertion in a distributed reputation network, the method comprising:
storing, by a contactless card, one or more unique data records, wherein the one or more unique data records uniquely identifies an entity;
transmitting, by the contactless card via an intermediary device, the one or more unique data records to a verification server;
verifying, by a verification server, the one or more unique data records stored on the contactless card;
generating, by the verification server upon verifying the one or more unique data records, a unique token identifier; and
distributing, by the verification server, the unique token identifier, in a reputation network,
wherein the verification server corresponds to a trusted entity, and
wherein the unique token identifier is configured to be used as a query identifier for querying one or more reputation providers on the reputation network.

2. The method of claim 1, wherein the one or more intermediary devices comprise a mobile device with a near field communication (NFC) reader storing an application configured to read the contactless card.

3. The method of claim 1, wherein the one or more reputation providers validate one or more reputation components associated with a user, the one or more reputation components comprising records corresponding to educational background, skills, and professional qualifications associated with the entity.

4. The method of claim 1, wherein distributing the unique token identifier by the verification server comprises inserting, by the verification server, the unique token identifier into one or more reputation data blocks as a metric of identity associated with the entity, the one or more reputation data blocks comprising one or more reputation components provided by one or more reputation providers, and wherein the one or more reputation data blocks are signed with a private key of a corresponding reputation provider.

5. The method of claim 4, further comprising adding, by the verification server, the reputation data blocks to the distributed reputation network comprising a plurality of reputation providers, wherein each of the plurality of reputation providers is authenticated using a corresponding public key associated with the reputation provider.

6. The method of claim 1, wherein distributing the unique token identifier, as a query identifier for the entity, in a reputation network, corresponds to storing the unique token identifier on a hierarchical deterministic (HD) hardware wallet, the unique token identifier comprising a digital signature of the verification server as the trusted entity.

7. The method of claim 6, wherein the HD hardware wallet is used to provide the unique token identifier, as the query identifier, to the reputation network.

8. The method of claim 1, wherein distributing the unique token identifier, as a query identifier for the entity, in a reputation network, corresponds to transmitting the unique token identifier to the contactless card for storage onto an integrated memory of the contactless card, wherein the contactless card is configured to transmit the unique token identifier, as a query identity, to the distributed reputation network, the unique token identifier comprising a digital signature of the verification server as the trusted entity.

9. The method of claim 1, wherein a reputation query comprises the unique token identifier and one or more reputation components.

10. The method of claim 1, wherein the distributed reputation network is implemented in a blockchain environment.

11. A system for implementing self-sovereign identification assertion in a distributed reputation network, the system comprising a contactless card in a communication with an authentication server, the communication being facilitated via an intermediary device, the contactless card being configured to:
store one or more unique data records, wherein the one or more unique data records uniquely identifies an entity; and
transmit, via the intermediary device, the one or more unique data records to the authentication server for verification; and
the authentication server being configured to:
verify, the one or more unique data records stored on the contactless card,
wherein the verification server corresponds to a trusted entity;
generate a unique token identifier upon verifying the one or more unique data records; and
distribute the unique token identifier, as a query identifier for the entity, in a reputation network,
wherein the unique token identifier is configured to be used as the query identifier for querying one or more reputation providers, on the reputation network, for one or more reputation components associated with the entity.

12. The system of claim 11, wherein communication between the contactless card and the authentication server is enabled by an application running on the intermediary device with near field communication (NFC) connectivity to the contactless card and network connectivity to the verification server.

13. The system of claim 11, wherein the one or more reputation components comprise records corresponding to one or more of educational background, accredited skills, and professional qualifications, associated with the entity.

14. The system of claim 11, wherein the verification server is further configured to insert the unique token identifier into one or more reputation data blocks as a metric of identity associated with the entity, the one or more reputation data blocks comprising one or more reputation components provided by the one or more reputation providers, the one or more reputation data blocks being signed with a private key of a corresponding reputation provider on the reputation network.

15. The system of claim 14, wherein the verification server is further configured to add the reputation data blocks to the reputation network.

16. The system of claim 11, wherein the verification server is further configured to transmit the unique token identifier to the contactless card for storage onto an integrated memory of the contactless card, wherein the contactless card is configured to transmit the unique token identifier, as a query identity, to the distributed reputation network.

17. A system of claim 11, wherein one or more values for each of the one or more reputation components are provided by the one or more reputation providers participating in the distributed reputation network.

18. A non-transitory computer-accessible medium comprising instructions for execution by a computer hardware arrangement, wherein, upon execution of the instructions the computer hardware arrange is configured to perform procedures comprising:
storing one or more unique data records on a contactless card, wherein the one or more unique data records uniquely identifies an entity;
transmitting, by the contactless card via an intermediary device, the one or more unique data records to a verification server;
verifying, by a verification server, the one or more unique data records stored on the contactless card;
generating, by the verification server upon verifying the one or more unique data records, a unique token identifier; and
distributing, by the verification server, the unique token identifier, in a reputation network,
wherein the verification server corresponds to a trusted entity, and
wherein the unique token identifier is configured to be used as a query identifier for querying one or more reputation providers on the reputation network.

19. The non-transitory computer-accessible medium of claim 18, further comprising instructions for inserting, by the verification server, the unique token identifier into one or more reputation data blocks as a metric of identity associated with the entity, the one or more reputation data blocks comprising one or more reputation components provided by one or more reputation providers, wherein the one or more reputation data blocks are signed with a private key of a corresponding reputation provider.

20. The non-transitory computer-accessible medium of claim 18, wherein distributing the unique token identifier, as a query identifier for the entity, in a reputation network, corresponds to transmitting the unique token identifier to the contactless card for storage onto an integrated memory of the contactless card, wherein the contactless card is configured to transmit the unique token identifier, as a query identity, to the distributed reputation network.
